(19) United States
(12) Patent Application Publication
(10) Pub. No.: US 2026/0105906 A1
(43) Pub. Date: Apr. 16, 2026

(54) GENERATIVE AUDIO EXTENSION

(71) Applicant: ADOBE INC., SAN JOSE, CA (US)

(72) Inventors: Prem Seetharaman, Sacramento, CA (US); Oriol Nieto-Caballero, Oakland, CA (US); Justin Jonathan Salamon, San Francisco, CA (US)

(21) Appl. No.: 18/916,334

(22) Filed: Oct. 15, 2024

(51) Int. Cl. G10K 15/02; G10L 13/08

(52) U.S. Cl. CPC G10K 15/02; G10L 13/08

(57) ABSTRACT

A method, apparatus, non-transitory computer readable medium, and system for audio processing include obtaining an input prompt representing a sound, generating a latent sound representation by denoising a noise input based on the input prompt, and generating a synthetic audio clip including the sound based on the latent sound representation.

### BACKGROUND

The following relates generally to audio processing, and more specifically to audio generation and extension using a machine learning model. Audio processing refers to the use of a computer to process, generate, or edit audio signals using an algorithm or processing network. In some cases, audio processing software can be employed for various tasks such as noise reduction, audio enhancement, sound synthesis, audio editing, audio generation, and audio extension. For example, audio generation involves using a machine learning model to generate new audio content based on a given input, and audio extension refers generating an additional audio sequence based on an initial prompt.

Audio generation is the production of sound or music based on an input data. For example, an audio generation process enables a model to generate music, speech, or sound effects from a text description, reference audio, or other input. In some cases, audio extension builds upon existing audio by extrapolating (e.g., generating additional audio content before or after the original audio) or interpolating (e.g., filling in additional content within the original audio sequence) using machine learning models to generate coherent and contextually appropriate audio that seamlessly continues from the original audio input.

### SUMMARY

A method, apparatus, non-transitory computer readable medium, and system for audio processing include obtaining an input prompt representing a sound, generating, using an audio generation model, a latent sound representation by denoising a noise input based on the input prompt, and generating, using the audio generation model, a synthetic audio clip including the sound based on the latent sound representation.

A method, apparatus, non-transitory computer readable medium, and system for training a machine learning model include obtaining a training set comprising an input audio clip and a text description, generating a first predicted audio clip based on the input audio clip, generating a second predicted audio clip based on the text description, and training, using the first predicted audio clip and the second predicted audio clip, an audio generation model to generate a synthetic audio clip.

An apparatus and system for audio processing include at least one processor, at least one memory storing instructions executable by the at least one processor, and an audio generation model trained to generate a latent sound representation by denoising a noise input based on an input prompt representing a sound, and to generate a synthetic audio clip including the sound based on the latent sound representation.

### BRIEF DESCRIPTION OF THE DRAWINGS

FIG. 1 shows an example of an audio processing system according to aspects of the present disclosure.

FIG. 2 shows an example of a method for conditional audio generation according to aspects of the present disclosure.

FIG. 3 shows an example of audio-to-audio generation according to aspects of the present disclosure.

FIG. 4 shows an example of text-to-audio generation according to aspects of the present disclosure.

FIG. 5 shows an example of video-to-audio generation according to aspects of the present disclosure.

FIG. 6 shows an example of a method for audio generation according to aspects of the present disclosure.

FIG. 7 shows an example of an audio processing apparatus according to aspects of the present disclosure.

FIG. 8 shows an example of a machine learning model according to aspects of the present disclosure.

FIG. 9 shows an example of an audio generation model according to aspects of the present disclosure.

FIG. 10 shows an example of a method for training a machine learning model according to aspects of the present disclosure.

FIG. 11 shows an example of a flow diagram depicting an algorithm as a step-by-step procedure in an example implementation of operations performable for training a machine learning model according to aspects of the present disclosure.

FIG. 12 shows an example of a method for training a diffusion model according to aspects of the present disclosure.

FIG. 13 shows an example of a computing device according to aspects of the present disclosure.

### DETAILED DESCRIPTION

The following relates to audio generation using generative machine learning models. Embodiments of the disclosure relate to an audio generation system that accurately and efficiently generates a synthetic audio clip that extends a background sound of an input audio clip. In one aspect, the system includes a preprocessing component configured to segment a foreground sound of the input audio clip and a background sound of the audio clip. In one aspect, the system includes an audio encoder trained to encode the background sound to generate a latent input representation. In one aspect, the system includes an audio generation model that generates a latent sound representation that represents an audio extension of the background sound. By using the latent input representation to guide the audio generation model, the system ensures that the audio content generation is consistent and coherent with the content of the input audio clip.

A sub-field in audio processing relates to audio extension or audio generation using generative machine learning models. In cases of video editing, an editor may edit the video by extending the visual (e.g., pixel) and audio content of an input audio clip. For example, the editor might need additional seconds of footage to smoothly transition between one clip to another clip, such as for a crossfade effect. However, in some cases, the original clip may end prematurely. Extending the visual and audio components of the video enables the editor to generate a target transition. Another common scenario arises when the video clip contains valuable content, but there is an undesirable element, such as a distracting noise or action at the end of the video, for example, a coughing noise. In such cases, the editor removes the final few seconds of the video that includes the distracting element and then extend both the video and audio to restore the clip to its original duration while preserving the continuity.

In dialogue editing within a video, a common use case involves re-recording dialogue to replace original dialogue that is unusable due to mistakes or unintelligibility. For example, editors search for segments where the background ambience or room tone (e.g., background sound effect) is audible, in order to reuse the background sound effect with the re-recorded dialogue, ensuring that the new audio sounds natural and consistent with the original footage. In some cases, this process can be highly time-consuming.

Some conventional audio generation system generates an audio clip based on a text conditioning. For example, these systems use a contrastive language-audio pretraining (CLAP) encoder to encode the text into text embeddings. The text embedding is used to condition the generated audio on the meaning of text, producing music that aligns with the given prompt. However, these systems include complex architecture that requires large number of parameters, making the system resource-intensive and complex to train. In some cases, these system is heavily dependent on fixed low latent rate, which limits the performance of the model for high-resolution audio tasks. In some cases, these systems are unable to perform tasks such as audio extension.

Accordingly, embodiments of the disclosure improve on conventional audio processing systems by efficiently and accurately generating a synthetic audio clip that includes additional background sound extending from the input audio clip. In some cases, the input audio clip includes a foreground sound (e.g., a speech) and a background sound (e.g., sounds effects or ambient sound). As a result, embodiments of the disclosure eliminate the need to manually find suitable audio segments within an audio clip and streamlines the audio editing process.

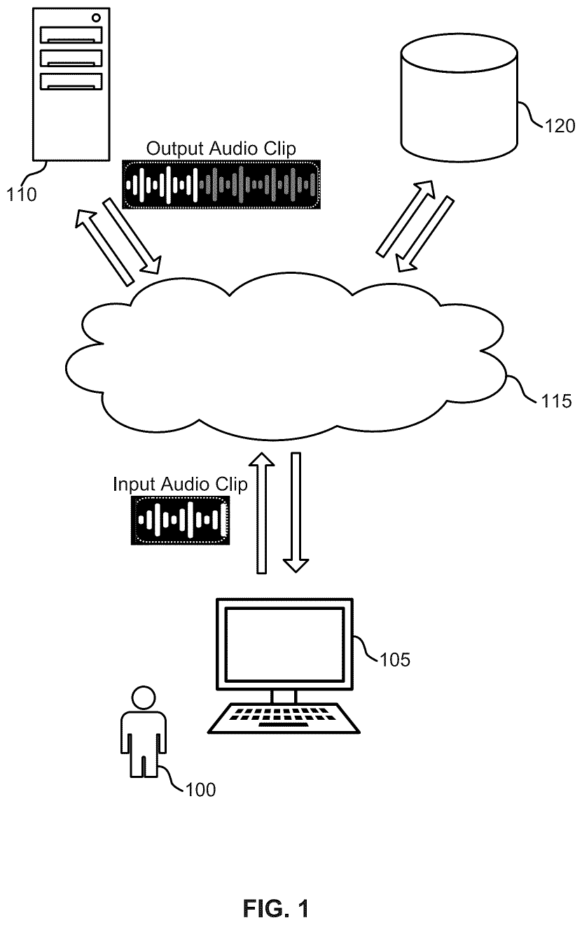

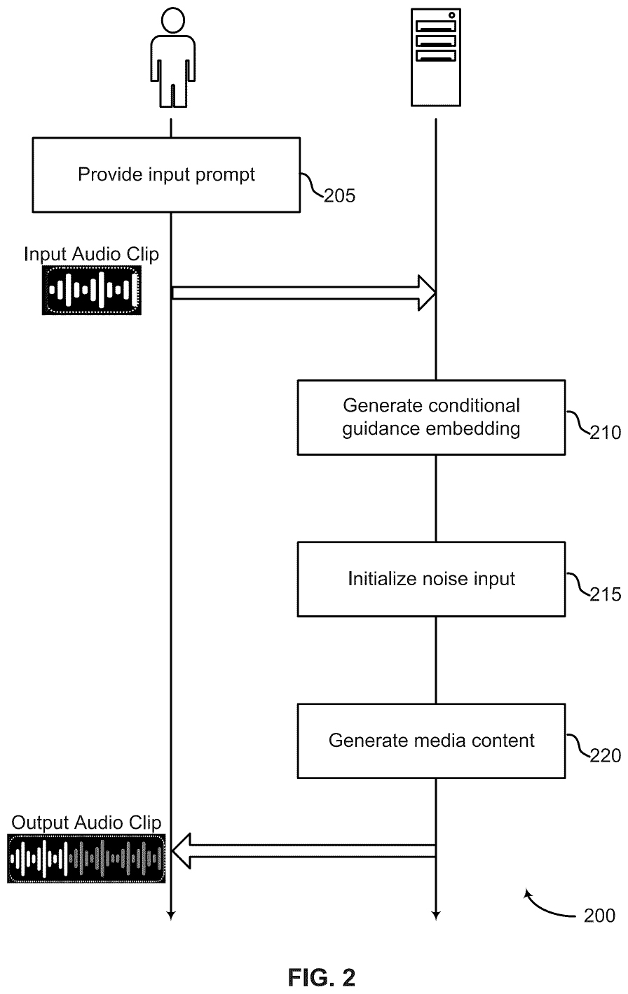

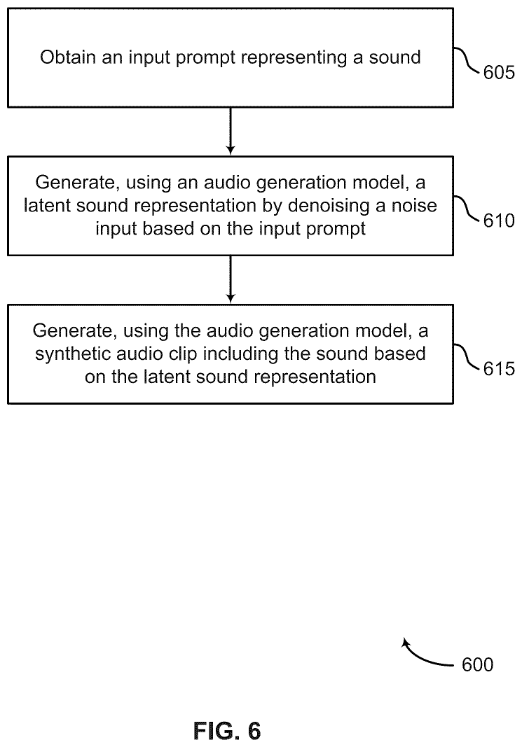

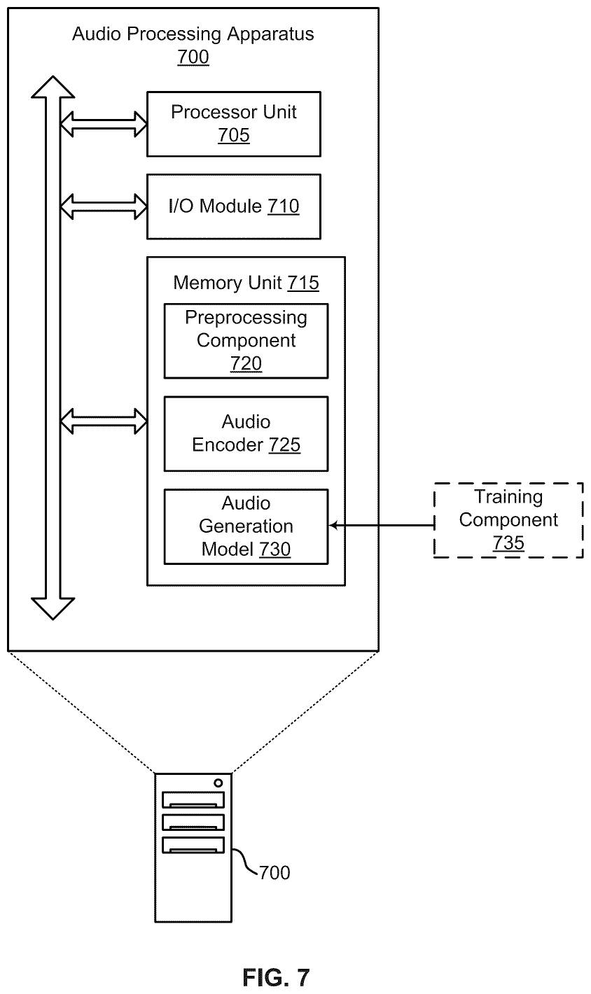

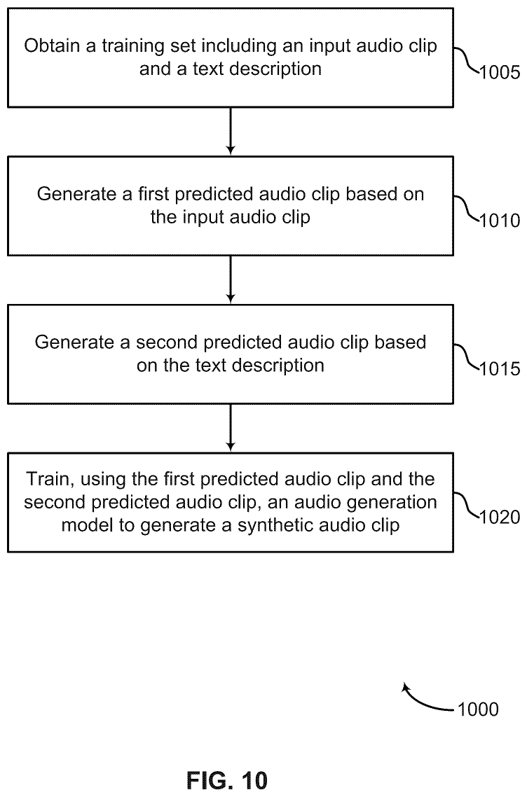

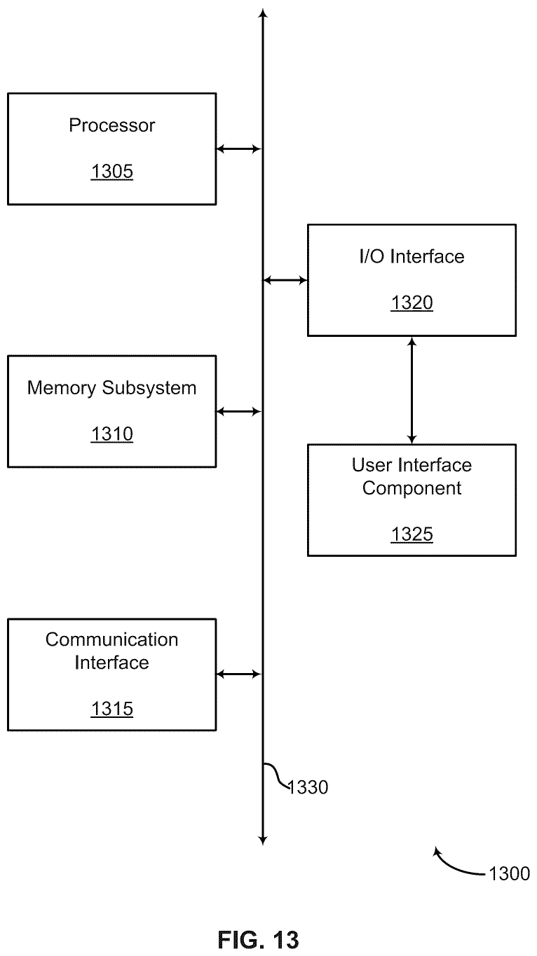

An example system of the inventive concept in audio processing is provided with reference to FIGS. 1 and 13. An example application of the inventive concept in audio processing is provided with reference to FIGS. 2-5. Details regarding the architecture of an audio processing apparatus are provided with reference to FIGS. 7-9. An example of a process for audio processing is provided with reference to FIG. 6. A description of an example training process is provided with reference to FIGS. 10-12.

Accordingly, the present disclosure provides a system and method that improve on conventional systems by accurately and efficiently generates a synthetic audio clip that extends a background sound of an input audio clip. In some aspects, the system includes a diffusion transformer (DiT) trained to generate audio extension. In some aspects, the system is jointly trained on audio extension and text-to-audio generation (e.g., sound effect generation) to enhance the audio extension quality. In some aspects, by using audio prompt guidance, the audio extension quality (e.g., the extension adherence) of the input audio is enhanced. In some cases, the audio clip includes a stereo audio multiple channels. By encoding the stereo audio using the audio encoder, accurate spatial positioning of the audio wave can be obtained, thus enhancing the audio quality of the synthetic audio clip. In some aspects, the system includes a preprocessing component configured to separate speech from the background sound in an input audio/video clip, thus reduces the generation of artifacts in the audio extensions of the background sound.

### Audio Generation and Extension

In FIGS. 1-6, a method, apparatus, non-transitory computer readable medium, and system for audio processing include obtaining an input prompt representing a sound, generating, using an audio generation model, a latent sound representation by denoising a noise input based on the input prompt, and generating, using the audio generation model, a synthetic audio clip including the sound based on the latent sound representation.

In some aspects, the input prompt comprises an input audio clip and the synthetic audio clip comprises an extension of the input audio clip. Some examples of the method, apparatus, non-transitory computer readable medium, and system further include encoding the input audio clip to obtain a latent input representation, wherein the latent sound representation is generated based on the latent input representation.

In some aspects, the sound comprises a background sound. Some examples of the method, apparatus, non-transitory computer readable medium, and system further include obtaining a preliminary audio clip. Some examples further include extracting the background sound from the preliminary audio clip to obtain the input prompt.

In some aspects, the input prompt comprises a text description of the sound. In some aspects, the synthetic audio clip comprises a plurality of spatial sound channels. In some aspects, the plurality of spatial sound channels comprises at least one mono channel and at least one side channel. In some aspects, the audio generation model is trained is using a training set including an input audio clip and a text description of the input audio clip.

FIG. 1 shows an example of an audio processing system according to aspects of the present disclosure. The example shown includes user 100, user device 105, audio processing apparatus 110, cloud 115, and database 120. In some aspects, audio processing apparatus 110 includes a machine learning model comprising a preprocessing component, an audio encoder-decoder, and an audio generation model. Audio processing apparatus 110 is an example of, or includes aspects of, the corresponding element described with reference to FIG. 7.

Referring to FIG. 1, user 100 provides an input prompt to audio processing apparatus 110 via user device 105 and cloud 115. For example, the input prompt includes an input audio clip, a text prompt, a video prompt, or a combination thereof. In some cases, for example, the input audio clip depicts a narrative voice with a background sound. In some embodiments, the preprocessing component extracts the background sound from the input audio clip. For example, the background sound may include sound effects such as car sounds, footsteps, explosions, animal sounds, etc. In some embodiments, the preprocessing component removes a foreground sound from the input audio clip. For example, the foreground sound includes speech.

In some embodiments, the audio encoder receives the input prompt (e.g., the extracted background sound) and generates a latent representation of the input prompt. The latent representation is used as guidance to guide the audio generation process of the audio generation model to generate the output audio clip. In one aspect, the output audio clip includes the original audio clip (e.g., the input audio clip) and a predicted audio clip that extends the background sound of the input audio clip. Audio processing apparatus 110 generates and returns the output audio clip to the user 100 using the user device 105 via cloud.

User device 105 may be a personal computer, laptop computer, mainframe computer, palmtop computer, personal assistant, mobile device, or any other suitable processing apparatus. In some examples, user device 105 includes software that incorporates an audio processing application. In some examples, the audio processing application on user device 105 may include functions of audio processing apparatus 110. In some cases, user device 105 may include a user interface that performs functions of the audio processing apparatus 110.

A user interface may enable user 100 to interact with user device 105. In some embodiments, the user interface may include an audio device, such as an external speaker system, an external display device such as a display screen, or an input device (e.g., a remote-controlled device interfaced with the user interface directly or through an I/O controller module). In some cases, a user interface may be a graphical user interface (GUI). In some examples, a user interface may be represented in code in which the code is sent to the user device 105 and rendered locally by a browser. The process of using the audio processing apparatus 110 is further described with reference to FIG. 2.

Audio processing apparatus 110 is an example of, or includes aspects of, the corresponding element described with reference to FIG. 7. According to some aspects, audio processing apparatus 110 includes a computer implemented network comprising a machine learning model, a preprocessing component, an audio encoder-decoder, and an audio generation model. Audio processing apparatus 110 further includes a processor unit, a memory unit, an I/O module, a user interface, and a training component. In some embodiments, audio processing apparatus 110 further includes a communication interface, user interface components, and a bus as described with reference to FIG. 13. Additionally or alternatively, audio processing apparatus 110 communicates with user device 105 and database 120 via cloud 115. Further detail regarding the operation of audio processing apparatus 110 is described with reference to FIG. 2.

In some cases, audio processing apparatus 110 is implemented on a server. A server provides one or more functions to users linked by way of one or more of the various networks. In some cases, the server includes a single microprocessor board, which includes a microprocessor responsible for controlling aspects of the server. In some cases, a server uses the microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user (e.g., user 100). The term cloud is sometimes used to describe data centers available to many users over the Internet. Some large cloud networks have functions distributed over multiple locations from central servers. A server is designated an edge server if the server has a direct or close connection to a user. In some cases, cloud 115 is limited to a single organization. In other examples, cloud 115 is available to many organizations. In one example, cloud 115 includes a multi-layer communications network comprising multiple edge routers and core routers. In some examples, cloud 115 is based on a local collection of switches in a single physical location.

According to some aspects, database 120 stores training data including an input audio clip and a text description. Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user (e.g., user 100) interacts with the database controller. In some cases, the database controller may operate automatically without user interaction.

FIG. 2 shows an example of a method 200 for conditional audio generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 205, the system provides input prompt. In some cases, the operations of this step refer to, or may be performed by, a user as described with reference to FIG. 1. In some cases, the user provides an input audio clip to the audio generation system. For example, the input audio clip may include various types of sounds such as speech, sound effect, music, etc. A preprocessing component is configured to generate an input prompt depicting background sound. For example, intelligent sound such as speech and music may be removed from the original input audio clip. In some embodiments, the input prompt is a text prompt that describes the sound to be generated or extended.

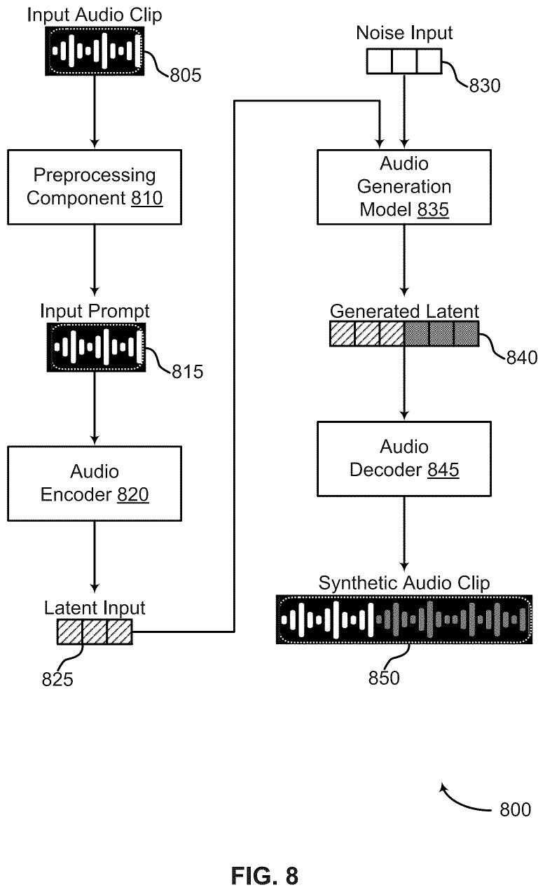

At operation 210, the system generates conditional guidance embedding. In some cases, the operations of this step refer to, or may be performed by, an audio processing apparatus as described with reference to FIGS. 1 and 7. In some cases, the operations of this step refer to, or may be performed by, an audio encoder as described with reference to FIGS. 7 and 8. In some cases, the audio encoder includes a variational autoencoder (VAE) trained to generate latent input representation representing the sound based on the input prompt. In some cases, the latent input representation may be an embedding, a token, or a latent feature. In some cases, the latent input representation is used to guide the audio generation process.

At operation 215, the system initializes noise input. In some cases, the operations of this step refer to, or may be performed by, an audio processing apparatus as described with reference to FIGS. 1 and 7. In some cases, the operations of this step refer to, or may be performed by, an audio generation model as described with reference to FIGS. 7 and 8. In some cases, the noise input including random noise is initialized. For example, the noise input is in a latent space. By initializing the audio generation model with random noise, different variations of synthetic audio clip including the content described by the text conditioning (e.g., the text prompt) or sound depicted by the input audio clip can be generated.

At operation 220, the system generates media content. In some cases, the operations of this step refer to, or may be performed by, an audio processing apparatus as described with reference to FIGS. 1 and 7. In some cases, the operations of this step refer to, or may be performed by, an audio generation model as described with reference to FIGS. 7 and 8. In some cases, for example, the media content includes a synthetic audio clip. In some cases, the synthetic audio clip includes the input audio clip and a background sound extension of the input audio clip. In some cases, the synthetic audio clip includes audio waves generated by the audio generation model.

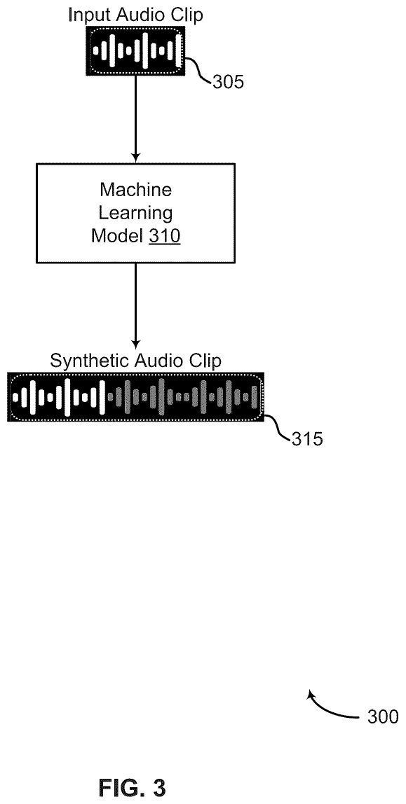

FIG. 3 shows an example of audio-to-audio generation according to aspects of the present disclosure. The example shown includes audio generation system 300, input audio clip 305, machine learning model 310, and synthetic audio clip 315. In some aspects, the audio generation system 300 is implemented in a user interface.

Referring to FIG. 3, audio generation system 300 receives input audio clip 305 and generates synthetic audio clip 315. In some cases, for example, machine learning model 310 includes a preprocessing component that generates an input prompt based on the input audio clip 305. For example, the preprocessing component detects whether the input audio clip includes music. In some cases, for example, the preprocessing component detects speech, if any, from the input audio clip 305, and removes the speech to generate the input prompt. In some cases, the input prompt is provided to an audio encoder as input. The audio encoder generates an input audio encoding in a latent space. Then, the input audio encoding and a random noise encoding is combined, where the combined encoding is provided to an audio generation model. The audio generation model is trained to generate an output audio encoding in the latent space representing subsequent background sound of the input audio clip 305. In some cases, an audio decoder decodes the output audio encoding to generate the synthetic audio clip 315 which depicts the original sound wave from input audio clip 305 followed by a synthetic audio wave representing the subsequent background sound (e.g., sound without the speech).

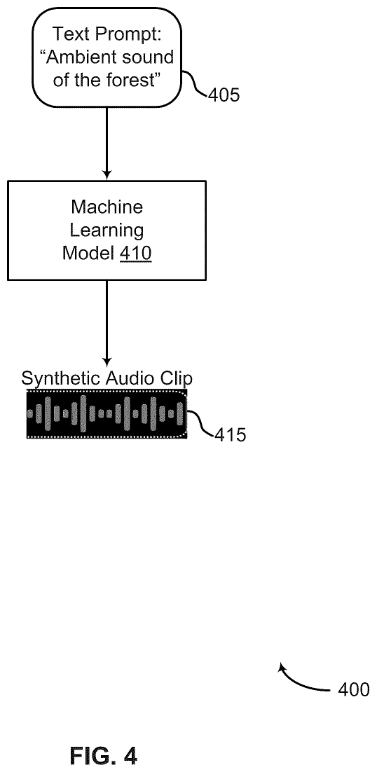

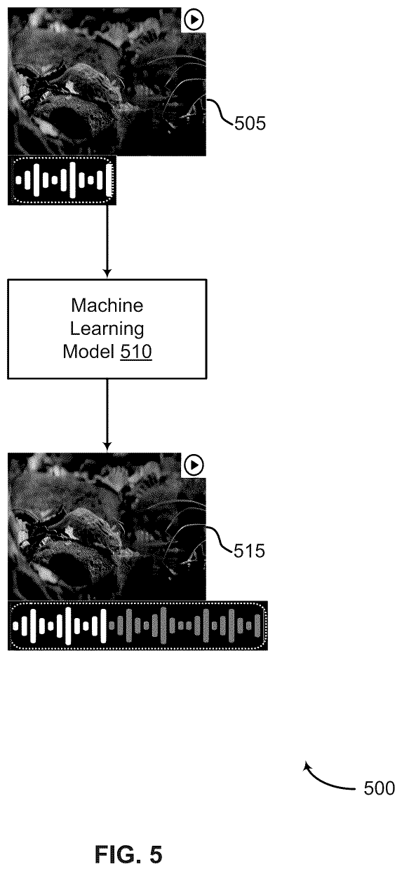

Audio generation system 300 is an example of, or includes aspects of, the corresponding element described with reference to FIGS. 4 and 5. Input audio clip 305 is an example of, or includes aspects of, the corresponding element described with reference to FIG. 8. Machine learning model 310 is an example of, or includes aspects of, the corresponding element described with reference to FIGS. 4 and 5. Synthetic audio clip 315 is an example of, or includes aspects of, the corresponding element described with reference to FIGS. 4 and 8.

FIG. 4 shows an example of text-to-audio generation according to aspects of the present disclosure. The example shown includes audio generation system 400, text prompt 405, machine learning model 410, and synthetic audio clip 415. In some aspects, the audio generation system 400 is implemented in a user interface.

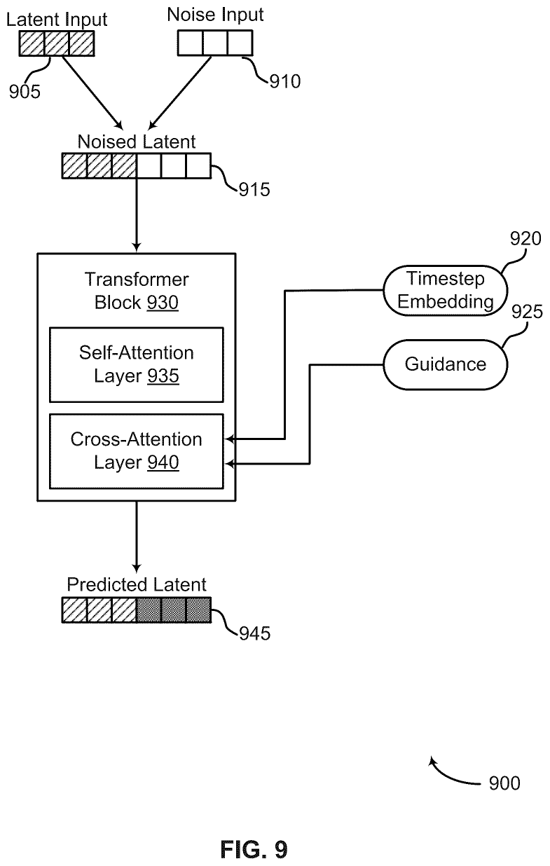

Referring to FIG. 4, audio generation system 400 receives text prompt 405 and generates synthetic audio clip 415. For example, the text prompt 405 states “Ambient sound of the forest.” In some cases, for example, machine learning model 410 receives the text prompt 405 and generates a text embedding based on the text prompt. In one embodiment, the text embedding is used to guide the audio generation process. For example, the audio generation model is initialized with random noise. Then, during the denoising process, the text embedding is combined to the intermediate features generated from the transformer block via cross-attention mechanism. The audio generation model is trained to generate an output audio encoding in the latent space representing sounds described by the text prompt 405. In some cases, an audio decoder decodes the output audio encoding to generate the synthetic audio clip 415 which depicts the sound wave. Further detail on the audio generation guidance is described with reference to FIG. 9

Audio generation system 400 is an example of, or includes aspects of, the corresponding element described with reference to FIGS. 3 and 5. Machine learning model 410 is an example of, or includes aspects of, the corresponding element described with reference to FIGS. 3 and 5. Synthetic audio clip 415 is an example of, or includes aspects of, the corresponding element described with reference to FIGS. 3 and 8.

FIG. 5 shows an example of video-to-audio generation according to aspects of the present disclosure. The example shown includes audio generation system 500, input video clip 505, machine learning model 510, and synthetic video clip 515. In some aspects, the audio generation system 500 is implemented in a user interface.

Referring to FIG. 5, audio generation system 500 receives input video clip 505 and generates synthetic video clip 515. For example, input video clip 505 includes a video (e.g., a sequence of images) and an audio clip (e.g., a sequence of sound waves). In some cases, the machine learning model 510 separates the video and the audio clip, where the audio clip is used as input prompt. Then, machine learning model 510 generates a synthetic audio clip as described with reference to FIG. 3. In some cases, the machine learning model 510 combines the original video and the synthetic audio clip to generate the synthetic video clip 515. In some embodiments, a separate video generation model or image generation model is used to generate or extend the video. Then, the generated video is combined with the synthetic audio clip to generation synthetic video clip 515.

Audio generation system 500 is an example of, or includes aspects of, the corresponding element described with reference to FIGS. 3 and 4. Machine learning model 510 is an example of, or includes aspects of, the corresponding element described with reference to FIGS. 3 and 4.

FIG. 6 shows an example of a method 600 for audio generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 605, the system obtains an input prompt representing a sound. In some cases, the operations of this step refer to, or may be performed by, an audio generation model as described with reference to FIGS. 7 and 8. In some cases, the input prompt includes an audio clip, a text prompt, or a video clip. For example, the audio clip may depict a sequence of sound waves. For example, a text prompt may describe a sound. For example, the video clip may depict a sequence of images and a sequence of sound waves.

In one aspect, sound, in terms of audio, refers to the electrical signal or digital data that represents acoustic waves for playback, recording, or processing by audio systems. Audio signals capture the variations in air pressure caused by sound waves, and these signals can be analyzed, modified, or reproduced through different technologies. In the context of audio, sound is often described based on one or more features such as waveform, sampling rate, bit depth, frequency response, dynamic range, harmonic content, and signal-to-noise ratio.

At operation 610, the system generates, using an audio generation model, a latent sound representation by denoising a noise input based on the input prompt. In some cases, the operations of this step refer to, or may be performed by, an audio generation model as described with reference to FIGS. 7 and 8. In some cases, an audio encoder is trained to encode the input prompt to generate a latent input representation. In some aspects, the latent input representation and the latent sound representation (e.g., the output of the audio generation model) are latent embeddings in the latent space. In some cases, an embedding is a continuous, dense vector representation of discrete tokens of the input prompt (e.g., the input audio clip). The embeddings points in a latent space that capture the semantic or structural meaning of the input. Each embedding is a high-dimensional vector that encodes the relationships and properties of the token the embedding represents. In some cases, the embedding is a low-dimensional vector. In some cases, the latent space is a low-dimensional vector space, thereby increasing the inference speed efficiency of the system.

At operation 615, the system generates, using the audio generation model, a synthetic audio clip including the sound based on the latent sound representation. In some cases, the operations of this step refer to, or may be performed by, an audio generation model as described with reference to FIGS. 7 and 8. In some cases, the synthetic audio clip includes the original input audio clip and a sequence of generated sound that represents a continuation or extension of the background sound of the audio clip. In some cases, the synthetic audio clip includes a sequence of generated sound described by the input text prompt.

In some aspects, the input audio clip includes a foreground sound and a background sound. For example, a foreground sound includes speech sound and a background sound includes ambient sound (such as rainfall sound, hum of AC, wind sound, footstep sound, etc.), sound effects (such as door creaking, beeping, glass shattering, etc.), or sounds that are not categorized as forms of intelligent sound (such as animal sound). In one aspect, intelligent sound is a form of sound that conveys information, ideas, and emotion. For example, intelligent sound includes speech or music.

### System Architecture

In FIGS. 7-9 and 13, an apparatus and system for audio processing include at least one processor, at least one memory storing instructions executable by the at least one processor, and an audio generation model trained to generate a latent sound representation by denoising a noise input based on an input prompt representing a sound, and to generate a synthetic audio clip including the sound based on the latent sound representation.

In some aspects, the audio generation model includes a diffusion transformer (DiT) model. In some aspects, the audio generation model includes a variational autoencoder (VAE).

FIG. 7 shows an example of an audio processing apparatus 700 according to aspects of the present disclosure. The example shown includes audio processing apparatus 700, processor unit 705, I/O module 710, memory unit 715, and training component 735. In one aspect, memory unit 715 includes preprocessing component 720, audio encoder 725, and audio generation model 730.

According to some embodiments of the present disclosure, Audio processing apparatus 700 includes a computer-implemented artificial neural network (ANN). An ANN is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted. Audio processing apparatus 700 is an example of, or includes aspects of, the corresponding element described with reference to FIG. 1.

Processor unit 705 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or any combination thereof). In some cases, processor unit 705 is configured to operate a memory array using a memory controller. In other cases, a memory controller is integrated into the processor. In some cases, processor unit 705 is configured to execute computer-readable instructions stored in a memory to perform various functions. In some embodiments, processor unit 705 includes special-purpose components for modem processing, baseband processing, digital signal processing, or transmission processing. Processor unit 705 is an example of, or includes aspects of, the processor described with reference to FIG. 13.

I/O module 710 (e.g., an input/output interface) may include an I/O controller. An I/O controller may manage input and output signals for a device. I/O controller may also manage peripherals not integrated into a device. In some cases, an I/O controller may represent a physical connection or port to an external peripheral. In some cases, an I/O controller may utilize an operating system such as iOS®, ANDROID®, MS-DOS®, MS-WINDOWS®, OS/2®, UNIX®, LINUX®, or another known operating system. In other cases, an I/O controller may represent or interact with a modem, a keyboard, a mouse, a touchscreen, or a similar device. In some cases, an I/O controller may be implemented as part of a processor. In some cases, a user may interact with a device via an I/O controller or via hardware components controlled by an I/O controller.

In some examples, I/O module 710 includes a user interface. A user interface may enable a user to interact with a device. In some embodiments, the user interface may include an audio device, such as an external speaker system, an external display device such as a display screen, or an input device (e.g., a remote control device interfaced with the user interface directly or through an I/O controller module). In some cases, a user interface may be a graphical user interface (GUI). In some examples, a communication interface operates at the boundary between communicating entities and the channel and may also record and process communications. A communication interface is provided herein to enable a processing system coupled to a transceiver (e.g., a transmitter and/or a receiver). In some examples, the transceiver is configured to transmit (or send) and receive signals for a communications device via an antenna. I/O module 710 is an example of, or includes aspects of, the I/O interface described with reference to FIG. 13.

Examples of memory unit 715 include random access memory (RAM), read-only memory (ROM), or a hard disk. Examples of memory unit 715 include solid-state memory and a hard disk drive. In some examples, memory unit 715 is used to store computer-readable, computer-executable software including instructions that, when executed, cause a processor to perform various functions described herein.

In some cases, memory unit 715 includes, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within memory unit 715 store information in the form of a logical state.

In one aspect, memory unit 715 includes a machine learning model. In one aspect, the machine learning model includes preprocessing component 720, audio encoder 725, and audio generation model 730. Memory unit 715 is an example, of, or includes aspects of, the memory subsystem described with reference to FIG. 13.

In some cases, the machine learning model is a computational algorithm, model, or system designed to recognize patterns, make predictions, or perform a specific task (for example, audio processing) without being explicitly programmed. According to some aspects, machine learning model is implemented as software stored in memory unit 715 and executable by processor unit 705, as firmware, as one or more hardware circuits, or as a combination thereof.

According to some embodiments of the present disclosure, machine learning model includes an ANN, which is a hardware or a software component that includes a number of connected nodes (e.g., artificial neurons), which loosely correspond to the neurons in a human brain. Each connection, or edge, transmits a signal from one node to another (like the physical synapses in a brain). When a node receives a signal, the node processes the signal and then transmits the processed signal to other connected nodes. In some cases, the signals between nodes comprise real numbers, and the output of each node is computed by a function of the sum of the inputs. In some examples, nodes may determine the output using other mathematical algorithms (e.g., selecting the max from the inputs as the output) or any other suitable algorithm for activating the node. Each node and edge is associated with one or more node weights that determine how the signal is processed and transmitted.

During the training process, the one or more node weights are adjusted to increase the accuracy of the result (e.g., by minimizing a loss function that corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on the corresponding inputs. The initial layer is known as the input layer and the last layer is known as the output layer. In some cases, signals traverse certain layers multiple times.

According to some embodiments, machine learning model includes a computer-implemented CNN. CNN is a class of neural networks commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (e.g., the receptive field). During a forward pass of the CNN, filters at each layer may be convolved across the input volume, computing the dot product between the filter and the input. During the training process, the filters may be modified so that the filters activate when the filters detect a particular feature within the input.

In one aspect, machine learning model includes machine learning parameters. Machine learning parameters, also known as model parameters or weights, are variables that provide behavior and characteristics of machine learning model. Machine learning parameters can be learned or estimated from training data and are used to make predictions or perform tasks based on learned patterns and relationships in the data.

Machine learning parameters are adjusted during a training process to minimize a loss function or maximize a performance metric. The goal of the training process is to find optimal values for the parameters that enables machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

According to some embodiments, machine learning model includes a computer-implemented recurrent neural network (RNN). An RNN is a class of ANN in which connections between nodes form a directed graph along an ordered (e.g., a temporal) sequence. This enables an RNN to model temporally dynamic behavior such as predicting what element should come next in a sequence. Thus, an RNN is suitable for tasks that involve ordered sequences such as text recognition (where words are ordered in a sentence). In some cases, an RNN includes one or more finite impulse recurrent networks (characterized by nodes forming a directed acyclic graph), one or more infinite impulse recurrent networks (characterized by nodes forming a directed cyclic graph), or a combination thereof.

According to some embodiments, machine learning model includes a transformer (or a transformer model, or a transformer network), where the transformer is a type of neural network model used for natural language processing tasks. A transformer network transforms one sequence into another sequence using an encoder and a decoder. The encoder and decoder include modules that can be stacked on top of each other multiple times. The modules comprise multi-head attention and feed-forward layers. The inputs and outputs (target sentences) are first embedded into an n-dimensional space. Positional encoding of the different words (e.g., give each word/part in a sequence a relative position since the sequence depends on the order of the elements) is added to the embedded representation (n-dimensional vector) of each word. In some examples, a transformer network includes an attention mechanism, where the attention looks at an input sequence and decides at each step which other parts of the sequence are important. The attention mechanism involves a query, keys, and values denoted by Q, K, and V, respectively. Q is a matrix that contains the query (vector representation of one word in the sequence), K are the keys (vector representations of the words in the sequence) and V are the values, which are again the vector representations of the words in the sequence. For the encoder and decoder, multi-head attention modules, V consists of the same word sequence as Q. However, for the attention module that takes into account the encoder and the decoder sequences, V is different from the sequence represented by Q. In some cases, values in V are multiplied and summed with some attention-weights a.

In the machine learning field, an attention mechanism (e.g., implemented in one or more ANNs) is a method of placing differing levels of importance on different elements of an input. Calculating attention may involve three basic steps. First, a similarity between the query and key vectors obtained from the input is computed to generate attention weights. Similarity functions used for this process can include the dot product, splice, detector, and the like. Next, a softmax function is used to normalize the attention weights. Finally, the attention weights are weighed together with the corresponding values. In the context of an attention network, the key and value are vectors or matrices that are used to represent the input data. The key is used to determine which parts of the input the attention mechanism should focus on, while the value is used to represent the actual data being processed.

An attention mechanism is a key component in some ANN architectures, particularly ANNs employed in natural language processing (NLP) and sequence-to-sequence tasks, that enables an ANN to focus on different parts of an input sequence when making predictions or generating output. Some sequence models (such as RNNs) process an input sequence sequentially, maintaining an internal hidden state that captures information from previous steps. However, in some cases, this sequential processing leads to difficulties in capturing long-range dependencies or attending to specific parts of the input sequence.

The attention mechanism addresses these difficulties by enabling an ANN to selectively focus on different parts of an input sequence, assigning varying degrees of importance or attention to each part. The attention mechanism achieves the selective focus by considering a relevance of each input element with respect to a current state of the ANN.

The term “self-attention” refers to a machine learning model in which representations of the input interact with each other to determine attention weights for the input. Self-attention can be distinguished from other attention models because the attention weights are determined at least in part by the input.

According to some aspects, preprocessing component 720 is implemented as software stored in memory unit 715 and executable by processor unit 705, as firmware, as one or more hardware circuits, or as a combination thereof. According to some aspects, preprocessing component 720 obtains a preliminary audio clip. In some examples, preprocessing component 720 extracts the background sound from the preliminary audio clip to obtain the input prompt.

According to some aspects, preprocessing component 720 obtains a preliminary audio clip. In some examples, preprocessing component 720 extracts a background sound from the preliminary audio clip to obtain the input audio clip. Preprocessing component 720 is an example of, or includes aspects of, the corresponding element described with reference to FIG. 8.

According to some aspects, audio encoder 725 is implemented as software stored in memory unit 715 and executable by processor unit 705, as firmware, as one or more hardware circuits, or as a combination thereof. According to some aspects, audio encoder 725 encodes the input audio clip to obtain a latent input representation, where the latent sound representation is generated based on the latent input representation. In some aspects, the audio encoder 725 includes a variational autoencoder (VAE).

In some aspects, audio encoder 725 encodes the input audio clip to generate a latent input representation of the sound. In some aspects, audio encoder 725 includes an audio decoder that converts the latent representation to the synthetic audio clip. Audio encoder 725 is an example of, or includes aspects of, the corresponding element described with reference to FIG. 8.

According to some aspects, audio generation model 730 is implemented as software stored in memory unit 715 and executable by processor unit 705, as firmware, as one or more hardware circuits, or as a combination thereof. According to some aspects, audio generation model 730 obtains an input prompt representing a sound. In some examples, audio generation model 730 generates a latent sound representation by denoising a noise input based on the input prompt. In some examples, audio generation model 730 generates a synthetic audio clip including the sound based on the latent sound representation. In some aspects, the audio generation model 730 is trained is using a training set including an input audio clip and a text description of the input audio clip.

In some aspects, the input prompt includes an input audio clip and the synthetic audio clip includes an extension of the input audio clip. In some aspects, the sound includes a background sound. In some aspects, the input prompt includes a text description of the sound. In some aspects, the synthetic audio clip includes a set of spatial sound channels. In some aspects, the set of spatial sound channels includes at least one mono channel and at least one side channel.

According to some aspects, audio generation model 730 generates a first predicted audio clip based on the input audio clip. In some examples, audio generation model 730 generates a second predicted audio clip based on the text description. In some examples, audio generation model 730 generates a third predicted audio clip based on the input audio clip and the text description.

According to some aspects, audio generation model 730 is trained to generate a latent sound representation by denoising a noise input based on an input prompt representing a sound, and to generate a synthetic audio clip including the sound based on the latent sound representation. In some aspects, the audio generation model 730 includes a diffusion transformer (DiT) model. In some aspects, the audio generation model 730 includes the audio encoder 725. Audio generation model 730 is an example of, or includes aspects of, the corresponding element described with reference to FIG. 8.

According to some aspects, audio processing apparatus 700 includes a training component 735. The training component 735 is implemented as software stored in memory unit 715 and executable by processor unit 705, as firmware, as one or more hardware circuits, or as a combination thereof. According to some embodiments, the training component 735 is implemented as software stored in a memory unit and executable by a processor in the processor unit of a separate computing device, as firmware in the separate computing device, as one or more hardware circuits of the separate computing device, or as a combination thereof. In some examples, the training component 735 is part of another apparatus other than audio processing apparatus 700 and communicates with the audio processing apparatus 700. In some examples, training component 735 is part of audio processing apparatus 700.

According to some aspects, training component 735 obtains a training set including an input audio clip and a text description. In some examples, training component 735 trains, using the first predicted audio clip and the second predicted audio clip, an audio generation model 730 to generate a synthetic audio clip. In some aspects, the first predicted audio clip is used to train the audio generation model 730 for an audio extension task and the second predicted audio clip is used to train the audio generation model 730 for a text-to-audio generation task.

In some examples, training component 735 computes an audio reconstruction loss based on the first predicted audio clip or the second predicted audio clip. In some examples, training component 735 updates parameters of the audio generation model 730 based on the audio reconstruction loss. In some aspects, the audio reconstruction loss is based on a set of spatial sound channels.

In some examples, training component 735 generates synthetic background noise, where the audio generation model 730 is trained based on the synthetic background noise. In some examples, training component 735 trains a variational autoencoder of the audio generation model 730 to decode the first predicted audio clip or the second predicted audio clip.

FIG. 8 shows an example of a machine learning model according to aspects of the present disclosure. The example shown includes machine learning system 800, input audio clip 805, preprocessing component 810, input prompt 815, audio encoder 820, latent input 825, noise input 830, audio generation model 835, latent sound representation 840, audio decoder 845, and synthetic audio clip 850. In one aspect, the machine learning system 800 includes a preprocessing component 810, an audio encoder 820, an audio generation model 835, and an audio decoder 845.

Referring to FIG. 8, machine learning system 800 receives input audio clip 805 and generate a synthetic audio clip 850. For example, the preprocessing component 810 receives the input audio clip 805 and generates an input prompt 815. For example, the preprocessing component 810 is configured to detect speech sound or music. In some embodiments, the preprocessing component 810 extracts sounds other than speech from input audio clip 805 to generate input prompt 815.

In some embodiments, the system performs audio segmentation which separates the input audio clip into three independent streams: speech, ambience or sound effects, and remaining sounds. In some cases, a foreground sound of the input audio clip include the speech and a background sound of the input audio clip includes the ambience sound effects and the remaining sounds. In some cases, the model extends the background sound while preserving the foreground sound, which enables for useful audio editing operations such as adding room tone, re-timing recorded speech, etc.

In some embodiments, the input prompt 815 is provided to the audio encoder 820 to generate the latent input 825 (e.g., the latent input representation). In some cases, the latent input 825 represents the sound in a form of embedding as described with reference to FIG. 6. In some cases, for example, the audio encoder 820 includes a variational autoencoder (VAE).

VAE is a generative model that combines deep learning and probabilistic techniques to learn a latent representation of input data (e.g., the input prompt 815). For example, VAE includes an encoder (e.g., the audio encoder 820) that compresses data into a probabilistic latent space by outputting parameters of a distribution (usually Gaussian), and a decoder (e.g., the audio decoder 845) that reconstructs the original data from samples drawn from this latent space. During training, VAEs optimize a loss function that balances reconstruction accuracy with a regularization term (KL divergence) to ensure the latent space follows a specified prior distribution. This enables VAEs to generate new, similar data samples and learn useful representations, making VAEs valuable for applications in data generation, representation learning, and semi-supervised learning.

In some embodiments, the audio generation model receives latent input 825 and noise input 830 and obtains latent sound representation 840. For example, latent input 825 and noise input 830 may be concatenated to obtain noised latent (as described with reference to FIG. 9), where the noised latent is used as input to the audio generation model 835. In some cases, a portion of the latent sound representation 840 represents the latent input 825 of the input prompt and a remaining portion of the latent sound representation 840 represents generated contents. In some cases, the audio generation model 835 includes a diffusion transformer (DiT) as described with reference to FIG. 9.

In some embodiments, the audio decoder 845 decodes the latent sound representation 840 from the embedding form to generate the synthetic audio clip 850 in the sound waveform consistent with the data type of the input audio clip 805. In some cases, the synthetic audio clip 850 includes a portion that depicts the original sound waves from the input audio clip 805 and a generated sound wave that depicts an extension of the background sound of the input audio clip 805. In some embodiments, the generated background sound may be prepended to the input audio clip 805, appended immediately subsequent to the input audio clip 805, extended in both direction of the input audio clip 805, or generated between one or more sequence gaps of the input audio clip 805. In some cases, the machine learning system 800 is configured to generate a synthetic audio clip that bridges two or more input audio clips, where the input audio clips may include similar background sounds or different background sounds.

According to some embodiments, the machine learning system 800 uses audio prompt guidance to further enhance the audio quality of the generated audio clip. For example, the audio prompt guidance is used to enhance the adherence of the generated audio clip to the original input audio clip. Since the machine learning system 800 is trained on extension, text-to-audio (without audio prompt), and no conditioning, a variant of classifier-free guidance can be used to improve the system performance at test-time. For example, the system is sampled twice when generating the audio clip. The first sample includes an extension conditioned based on the audio prompt, and the second sample includes an extension that is not conditioned. Then, the generation is guided towards the first sample and away from the second sample. Accordingly, the system is able to generate higher audio quality with enhanced adherence to the input prompt (e.g., the input audio clip 805).

According to some aspects, the system includes an audio encoder 820. For example, the audio encoder 820 is a variational autoencoder (VAE) for audio. In some aspects, the audio encoder 820 is able to encode stereo audio of difference types to generate audio encodings (e.g., the latent input 825). In some aspects, the audio encodings includes spatial positioning of the input audio clip 805. For example, the audio sound or audio wave from the input audio clip 805 is parametrized into mono (e.g., the sum of the left and right channels) and side (the difference of the left and right channels) when encoding the input audio clip into the latent space. In some cases, the training component computes a reconstruction loss (e.g., the difference between waveforms, spectrograms, etc.) and use the reconstruction loss to update parameters of the audio encoder 820.

Input audio clip 805 is an example of, or includes aspects of, the corresponding element described with reference to FIG. 3. Preprocessing component 810 is an example of, or includes aspects of, the corresponding element described with reference to FIG. 7. Audio encoder 820 is an example of, or includes aspects of, the corresponding element described with reference to FIG. 7.

Noise input 830 is an example of, or includes aspects of, the corresponding element described with reference to FIG. 9. Audio generation model 835 is an example of, or includes aspects of, the corresponding element described with reference to FIG. 7. Synthetic audio clip 850 is an example of, or includes aspects of, the corresponding element described with reference to FIGS. 3 and 4.

FIG. 9 shows an example of an audio generation model according to aspects of the present disclosure. The example shown includes diffusion transformer 900, latent input 905, noise input 910, noised latent 915, timestep embedding 920, guidance 925, transformer block 930, and predicted latent 945. In one aspect, transformer block 930 includes self-attention layer 935 and cross-attention layer 940. Noise input 910 is an example of, or includes aspects of, the corresponding element described with reference to FIG. 8.

According to some aspect, the machine learning system 800 as described with reference to FIG. 8 includes a diffusion transformer (DiT) model (e.g., diffusion transformer 900). In some cases, the model is trained on large quantity of training data to enhance the model scalability. In some cases, the model is trained to generalize on new classes such as nature sound, non-stationary sound, etc.

According to some aspects, diffusion transformer 900 receives latent input 905 and noise input 910 to generate predicted latent 945. For example, the latent input 905 and noise input 910 are combined (or concatenated) to generate noised latent 915. The noised latent 915 is provided to the transformer block 930 to generate an intermediate feature. For example, the self-attention layer 935 receives the noised latent 915 and generates an intermediate feature and the intermediate feature is passed to the next neural network layer (e.g., a cross-attention layer 940) to generate the next intermediate layer. In some cases, the cross-attention layer 940 receives additional inputs such as timestep embedding 920 representing the diffusion timestep and guidance 925 via cross-attention mechanism to generate the predicted latent 945. In some embodiments, the next intermediate layer is provided to a second transformer block including a self-attention layer and a cross-attention layer to generate the predicted latent 945.

According to some embodiments, the guidance 925 includes a text embedding of a text prompt, a video embedding or a video input, and an audio embedding or an audio input. For example, a text prompt describing a sound may be provided to a text encoder of the system to generate the text embedding to guide the audio generation process within the diffusion transformer 900. For example, the latent input 905 may be used as the guidance 925 to guide the audio generation process within the diffusion transformer 900. For example, a video depicting a sequence of images and sound waves may be provided to a video encoder (or a multimodal encoder) of the system to generate the video embedding to guide the audio generation process within the diffusion transformer 900.

The term “self-attention” refers to a machine learning model in which representations of the input interact with each other to determine attention weights for the input. Self-attention can be distinguished from other attention models because the attention weights are determined at least in part by the input.

Cross-attention, also known as multi-head attention, is an extension of the attention mechanism used in some ANNs, for example, for NLP tasks. In some cases, cross-attention attends to multiple parts of an input sequence simultaneously, capturing interactions and dependencies between different elements. In cross-attention, there are two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring the similarity between each query representation and the key representations, where a higher similarity indicates that more attention is given to a key element. An attention score indicates the importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, enabling the machine learning model to understand the context and generate more accurate and contextually relevant outputs.

### Training and Evaluation

A method, apparatus, non-transitory computer readable medium, and system for training a machine learning model include obtaining a training set comprising an input audio clip and a text description, generating a first predicted audio clip based on the input audio clip, generating a second predicted audio clip based on the text description, and training, using the first predicted audio clip and the second predicted audio clip, an audio generation model to generate a synthetic audio clip.

In some aspects, the first predicted audio clip is used to train the audio generation model for an audio extension task. In some aspects, the second predicted audio clip is used to train the audio generation model for a text-to-audio generation task.

Some examples of the method, apparatus, non-transitory computer readable medium, and system further include computing an audio reconstruction loss based on the first predicted audio clip or the second predicted audio clip. Some examples further include updating parameters of the audio generation model based on the audio reconstruction loss. In some aspects, the audio reconstruction loss is based on a plurality of spatial sound channels.

Some examples of the method, apparatus, non-transitory computer readable medium, and system further include generating synthetic background noise, wherein the audio generation model is trained based on the synthetic background noise. Some examples of the method, apparatus, non-transitory computer readable medium, and system further include obtaining a preliminary audio clip. Some examples further include extracting a background sound from the preliminary audio clip to obtain the input audio clip.

Some examples of the method, apparatus, non-transitory computer readable medium, and system further include generating a third predicted audio clip based on the input audio clip and the text description. Some examples of the method, apparatus, non-transitory computer readable medium, and system further include training a variational autoencoder of the audio generation model to decode the first predicted audio clip or the second predicted audio clip.

FIG. 10 shows an example of a method 1000 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system obtains a training set including an input audio clip and a text description. In some cases, the operations of this step refer to, or may be performed by, a training component as described with reference to FIG. 7.

At operation 1010, the system generates a first predicted audio clip based on the input audio clip. In some cases, the operations of this step refer to, or may be performed by, an audio generation model as described with reference to FIGS. 7 and 8. In some cases, the first predicted audio clip is used to train the audio generation model for an audio extension task.

At operation 1015, the system generates a second predicted audio clip based on the text description. In some cases, the operations of this step refer to, or may be performed by, an audio generation model as described with reference to FIGS. 7 and 8. In some cases, the second predicted audio clip is used to train the audio generation model for a text-to-audio generation task

At operation 1020, the system trains, using the first predicted audio clip and the second predicted audio clip, an audio generation model to generate a synthetic audio clip. In some cases, the operations of this step refer to, or may be performed by, a training component as described with reference to FIG. 7. In some cases, the audio generation model is trained based on one or more tasks including generating an audio output based on an audio input, generating an audio output based on a text input, generating an audio output based on a text input and an audio input, and generating an audio output based on no input (e.g., initialized from random noise).

In some aspects, the audio generation model is augmented with mask tokens, where the mask tokens indicates whether a token represents audio prompt or represents an extension to be generated. For example, the mask token may be placed in arbitrary position in a sequence, which enables multiple types of audio editing operators. In one aspect, the mask tokens is used for audio extension (e.g., in either forward direction or a backward direction). In some aspects, the model is able to performed audio outpainting (e.g., expanding in forward and backward directions at the same time), inpainting (e.g., regenerating a segment of the audio within the input audio clip), or transition (e.g., generating transitional audio clip that combines a first audio clip and a second audio clip). During the training stage, a random audio prompt is sampled, and the model is trained based on the sampled audio prompt (e.g., either to perform outpainting, inpainting, extension, or transition). In some cases, the model is trained with text conditioning which enables the model to perform text-to-audio generation and text-guided extension.

In some cases, during training, the model is fine-tuned to mitigate hallucination. For example, the model is fine-tuned on a synthetic dataset that includes stationary sounds, which includes ambience, room tone, white noise, etc. In some cases, the synthetic dataset includes 1.3 M hours of noise floor data. For example, the noise floor data includes room tone data and white noise data. Room tone data is an audio dataset from, for example, LibriVox. In some cases, room tone data is preprocessed to remove the speech. For example, room tone data includes background sound such as room tone or ambient sound. White noise is a sound that contains all audible sound frequencies played at the same intensity. It's often described as a “shh” sound, similar to the sound of a fan, air conditioner, or TV static. In some cases, the white noise is generated to have a target length n of the audio file to be generated.

In some embodiments, the noise floor data is generated by randomly sampling n seconds from a random file of the room tone data. The sampled audio is convolved with the generated white noise of the same length to obtaining white noise that matches the frequency response of the room tone thus effectively synthesizing a new and unique n seconds long audio file containing noise floor. To obtain stereo room tone, the aforementioned process is repeated for each of the two channels. In one aspect, the noise floor dataset includes a total of 100k files, and n is set to 13.

To mitigate hallucinations, the model is finetuned with the noise floor dataset. For example, the model is trained using the synthesized data. For example, the model is finetuned to either generate 10 seconds of forward/backward extensions (i.e., no in-painting) given a 3-seconds prompt. In some cases, the model is finetuned with different number of finetuning iterations: 10k, 15k, and 20k.

In some cases, the audio encoder is trained based on stereo width augmentation. For example, the audio sound or audio wave from the input audio clip is parametrized into mono and side as described in FIG. 8. In some cases, the ratio of the mono and sound is adjusted to a predetermined ratio. In some cases, the audio encoder is trained based on the training data including stereo sounds having a mono channel and a side channel with the predetermined ratio.

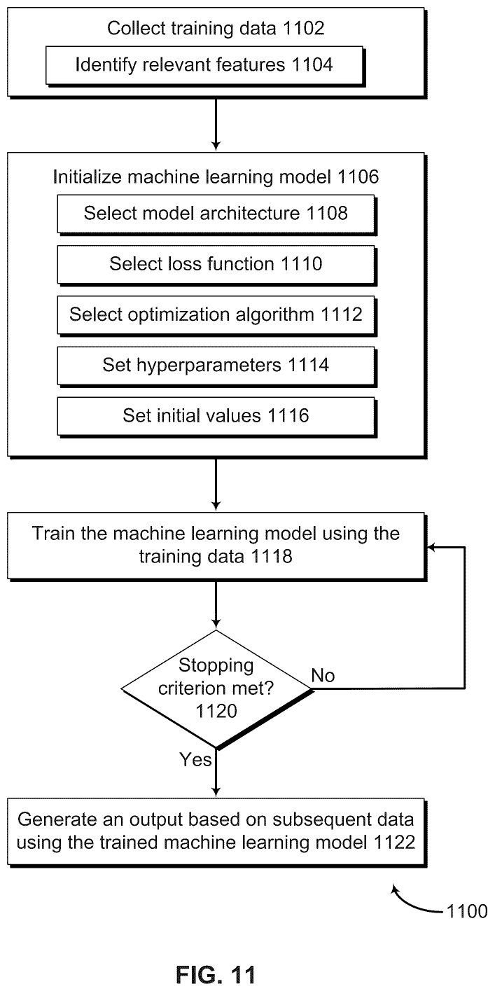

FIG. 11 shows an example of a flow diagram depicting an algorithm as a step-by-step procedure in an example implementation of operations performable for training a machine learning model according to aspects of the present disclosure. In some embodiments, the procedure 1100 describes an operation of the training component 735 described for configuring the audio generation model 730 as described with reference to FIG. 7. The procedure 1100 provides one or more examples of generating training data, use of the training data to train a machine-learning model, and use of the trained machine-learning model to perform a task.

To begin in this example, a machine-learning system collects training data (block 1102) to be used as a basis to train a machine-learning model, which defines what is being modeled. The training data is collectible by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, U-Net architecture, etc.

A loss function is also selected (block 1110). The loss function is utilized to measure a difference between an output of the machine-learning model (e.g., the model predictions) and target values (e.g., as expressed by the training data) to be used to train the machine-learning model. Additionally, an optimization algorithm is selected (block 1112) to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1116) examples of which include initializing weights and biases of nodes to increase efficiency in training and computational resources consumption as part of training. Hyperparameters are also set (block 1114) that are used to control training of the machine learning model, examples of which include regularization parameters, model parameters (e.g., a number of layers in a neural network), learning rate, batch sizes selected from the training data, and so on. The hyperparameters are set using a variety of techniques, including the use of a randomization technique, through the use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through the use of the selected loss function and backpropagation to optimize the performance of the machine-learning model to perform an associated task.

As part of training the machine-learning model, a determination is made as to whether a stopping criterion is met (decision block 1120), which is used to validate the machine-learning model. The stopping criterion is usable to reduce the overfitting of the machine-learning model, reduce computational resource consumption, and promote the ability of the machine-learning model to address unseen data not included as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), procedure 1100 continues the training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model.

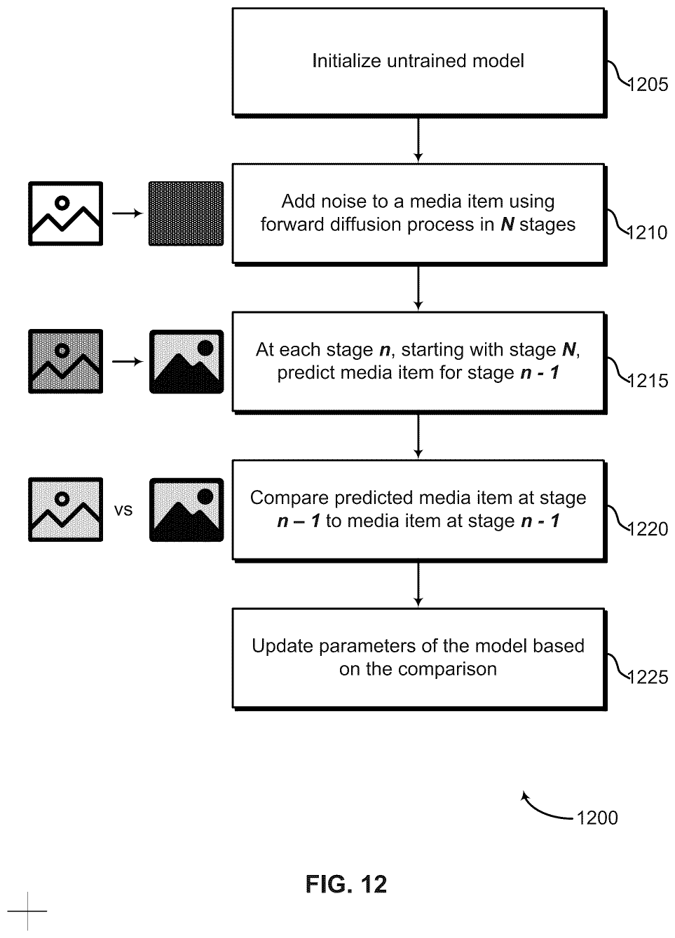

FIG. 12 shows an example of a method for training a diffusion model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

In some embodiments, the method 1200 describes an operation of the training component 735 described for training the audio generation model 730 as described with reference to FIG. 7. The method 1200 represents an example for training a diffusion process as described above with reference to FIG. 9. In some examples, these operations are performed by a system including a processor executing a set of codes to control functional elements of an apparatus, such as the audio generation model described in FIG. 7.

At operation 1205, the system initializes untrained model. In some cases, the operations of this step refer to, or may be performed by, a training component as described with reference to FIG. 7. Initialization can include defining the architecture of the model and establishing initial values for the model parameters. In some cases, the initialization can include defining hyper-parameters such as the number of layers, the resolution and channels of each layer block, the location of skip connections, and the like.

At operation 1210, the system adds noise to media item using forward diffusion process in N stages. In some cases, the operations of this step refer to, or may be performed by, a training component as described with reference to FIG. 7. In some cases, for example, the media item is a training image. In some cases, the forward diffusion process is a fixed process where Gaussian noise is successively added to the media item (such as an original image). In latent diffusion models, the Gaussian noise may be successively added to features in a latent space.

At operation 1215, the system at each stage n, starting with stage N, predict media item for stage n-1. In some cases, the operations of this step refer to, or may be performed by, a training component as described with reference to FIG. 7. In some cases, the media item is a synthetic audio clip generated using the audio generation model. For example, the reverse diffusion process can predict the noise that was added by the forward diffusion process, and the predicted noise can be removed from the noise input to obtain the predicted output. In some cases, an original media item is predicted at each stage of the training process.

At operation 1220, the system compares the predicted media item (or feature) at stage n-1 to media at stage n-1. In some cases, for example, the system compares the synthetic audio (or predicted audio feature) at state n-1 to the ground-truth audio (or ground-truth feature) at state n-1. In some cases, the operations of this step refer to, or may be performed by, a training component as described with reference to FIG. 7. For example, given observed data x, the diffusion model may be trained to minimize the variational upper bound of the negative log-likelihood −log p_{θ}(x) of the training data.

At operation 1225, the system updates parameters of the model based on the comparison. In some cases, the operations of this step refer to, or may be performed by, a training component as described with reference to FIG. 7. For example, parameters of a U-Net may be updated using gradient descent. Time-dependent parameters of the Gaussian transitions can also be learned.

### Computing Device

FIG. 13 shows an example of a computing device according to aspects of the present disclosure. The example shown includes computing device 1300, processor 1305, memory subsystem 1310, communication interface 1315, I/O interface 1320, user interface component 1325, and channel 1330.

In some embodiments, computing device 1300 is an example of, or includes aspects of, the audio processing apparatus described with reference to FIGS. 1 and 7. In some embodiments, computing device 1300 includes processor 1305 that can execute instructions stored in memory subsystem 1310 to obtain an input prompt representing a sound, generate a latent sound representation by denoising a noise input based on the input prompt, and generate a synthetic audio clip including the sound based on the latent sound representation.

According to some embodiments, processor 1305 includes one or more processors. In some cases, processor 1305 is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof. In some cases, processor 1305 is configured to operate a memory array using a memory controller. In other cases, a memory controller is integrated into processor 1305. In some cases, processor 1305 is configured to execute computer-readable instructions stored in a memory to perform various functions. In some embodiments, processor 1305 includes special-purpose components for modem processing, baseband processing, digital signal processing, or transmission processing. Processor 1305 is an example of, or includes aspects of, the processor unit described with reference to FIG. 7.

According to some embodiments, memory subsystem 1310 includes one or more memory devices. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) that controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state. Memory subsystem 1310 is an example of, or includes aspects of, the memory unit described with reference to FIG. 7.

According to some embodiments, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna. In some cases, a bus is used in communication interface 1315.

According to some embodiments, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or hardware components controlled by the I/O controller. I/O interface 1320 is an example of, or includes aspects of, the I/O module described with reference to FIG. 7.

According to some embodiments, user interface component 1325 enables a user to interact with computing device 1300. In some cases, user interface component 1325 includes an audio device, such as an external speaker system, an external display device such as a display screen, an input device (e.g., a remote-control device interfaced with a user interface directly or through the I/O controller), or a combination thereof.

The performance of apparatus, systems, and methods of the present disclosure have been evaluated, and results indicate embodiments of the present disclosure have obtained increased performance over conventional technology (e.g., conventional audio generation models). Example experiments demonstrate that the audio processing apparatus based on the present disclosure outperforms conventional audio generation models. Details on the example use cases based on embodiments of the present disclosure are described with reference to FIGS. 3-5.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt representing a sound;
generating, using an audio generation model, a latent sound representation by denoising a noise input based on the input prompt; and
generating, using the audio generation model, a synthetic audio clip including the sound based on the latent sound representation.

2. The method of claim 1, wherein:
the input prompt comprises an input audio clip and the synthetic audio clip comprises an extension of the input audio clip.

3. The method of claim 2, further comprising:
encoding the input audio clip to obtain a latent input representation, wherein the latent sound representation is generated based on the latent input representation.

4. The method of claim 1, wherein:
the sound comprises a background sound.

5. The method of claim 4, wherein obtaining the input prompt comprises:
obtaining a preliminary audio clip; and
extracting the background sound from the preliminary audio clip to obtain the input prompt.

6. The method of claim 1, wherein:
the input prompt comprises a text description of the sound.

7. The method of claim 1, wherein:
the synthetic audio clip comprises a plurality of spatial sound channels.

8. The method of claim 7, wherein:
the plurality of spatial sound channels comprises at least one mono channel and at least one side channel.

9. The method of claim 1, wherein:
the audio generation model is trained is using a training set including an input audio clip and a text description of the input audio clip.

10. A method of training a machine learning model comprising:
obtaining a training set comprising an input audio clip and a text description;
generating a first predicted audio clip based on the input audio clip;
generating a second predicted audio clip based on the text description; and
training, using the first predicted audio clip and the second predicted audio clip, an audio generation model to generate a synthetic audio clip.

11. The method of claim 10, wherein:
the first predicted audio clip is used to train the audio generation model for an audio extension task and the second predicted audio clip is used to train the audio generation model for a text-to-audio generation task.

12. The method of claim 10, wherein training the audio generation model comprises:
computing an audio reconstruction loss based on the first predicted audio clip or the second predicted audio clip; and
updating parameters of the audio generation model based on the audio reconstruction loss.

13. The method of claim 12, wherein:
the audio reconstruction loss is based on a plurality of spatial sound channels.

14. The method of claim 10, wherein obtaining the training set comprises:
generating synthetic background noise, wherein the audio generation model is trained based on the synthetic background noise.

15. The method of claim 10, wherein obtaining the training set comprises:
obtaining a preliminary audio clip; and
extracting a background sound from the preliminary audio clip to obtain the input audio clip.

16. The method of claim 10, further comprising:
generating a third predicted audio clip based on the input audio clip and the text description.

17. The method of claim 10, further comprising:
training a variational autoencoder of the audio generation model to decode the first predicted audio clip or the second predicted audio clip.

18. An apparatus comprising:
at least one processor;
at least one memory storing instructions executable by the at least one processor; and
an audio generation model trained to generate a latent sound representation by denoising a noise input based on an input prompt representing a sound, and to generate a synthetic audio clip including the sound based on the latent sound representation.

19. The apparatus of claim 18, wherein:
the audio generation model includes a diffusion transformer (DiT) model.

20. The apparatus of claim 18, wherein:
the audio generation model includes a variational autoencoder (VAE).
